(19) United States
(12) Patent Application Publication
(10) Pub. No.: US 2011/0156288 A1
(43) Pub. Date: Jun. 30, 2011

(54) ULTRASONIC AROMA HUMIDIFIER CAPABLE OF FACILITATING CLEANING

(76) Inventor: Seok Hwan Ahn, Daegu (KR)

(21) Appl. No.: 13/060,268

(22) PCT Filed: Jul. 23, 2009
(86) PCT No.: PCT/KR2009/004103

§ 371 Date: Feb. 22, 2011

(30) Foreign Application Priority Data
Aug. 20, 2008 (KR) 10-2008-0081246

(51) Int. Cl. F24F 6/12; B01F 3/04

(52) U.S. Cl. 261/30

(57) ABSTRACT

The present device concerns an ultrasonic aroma humidifier which facilitates cleaning. For this purpose, the present device comprises a main body, a vaporizer which is coupled with the bottom of the main body, and a base. The main body includes a water shortage indicating lamp, and a handle with a built-in air blowing port, wherein a water container and a water container mount are formed. The vaporizer includes: an ultrasonic oscillator which generates sprayed mist through an ultrasonic oscillation, a water level detecting sensor which detects the water level, a circuit board for controlling the ultrasonic oscillator when there is a lack of water and turning on and off the water shortage indicating lamp, and an electric connector which supplies electric power to the ultrasonic oscillator. The base houses an electric connection protrusion which is coupled with the electric connector, ultrasonic oscillation and control circuits which respectively drive and control the vaporizer, a blowing fan for taking in external air, a humidifying switch which regulates the degree of humidification, a blowing switch which regulates blowing intensity, and a power source cord. The top of the main body is coupled with a cover in which a humidifying outlet for discharging humidifying particles and a nozzle are included. In the inner side of the main body, an attachable/detachable filter net storing aroma and cosmetic materials and a stationary ring are included. According to the constitution as the above mentioned ultrasonic humidifier, since the main body has a function as a water tank and a humidifying body, and the air blowing port is handle-shaped, the internal structure is simple. Cleaning and water supply are easy and free because the main body is independently separated from the base wherein an electric circuit and a blowing fan are embedded, using an electric power transmitting method at a contact point. In addition, position change and installation are free and humidification and aroma and cosmetic material discharge are simultaneously enabled by letting a user freely add aroma and cosmetic materials because the filter net for aroma is formed inside the main body.

### TECHNICAL FIELD

The present invention relates to an ultrasonic aroma humidifier capable of facilitating cleaning.

### BACKGROUND ART

Humidifiers are devices that spray water into the air to maintain humidity that is pleasant and good for human bodies and used to remove respiratory illness and atopic disease etc. due to dry air in an interior or in winter. The humidifiers used for this purpose are largely divided into a heating type, an ultrasonic type, and a composite type.

The present invention relates to the ultrasonic humidifier and an ultrasonic humidifier of the related art is described hereafter.

FIG. 1 is a view showing the top of a humidifying chamber of an ultrasonic humidifier of the related art and FIG. 2 is a cross-sectional view of the ultrasonic humidifier of the related art. As shown in the figures, a water tank seat 21 where a water tank 10 is seated, an ultrasonic oscillator 25 humidifying the interior air by spraying, an air blowing port 26 discharging the sprayed water, and a water level detecting sensor 27 detecting the amount of water for spraying are formed on the top of a humidifier main body 20. The water tank seat 21 has a protrusion 22, such that when the water tank 10 is seated on the humidifier main body 20, a spring type of water supply port 12 in a cover 11 of the water tank is opened and a predetermined amount of water flows into a humidifying chamber 24 through a connection pipe 23. The water level sensor 27 stops the humidification when the water flowing in the humidifying chamber 24 reduces under a predetermined level. In the ultrasonic oscillator 25 and the blowing fan 28 of the configuration, the degree of humidification and the blowing intensity are controlled by an electronic circuit (not shown) that receives operational intensity of the humidifier by a user operating keys of a key input unit 31, such that the water is discharged for humidification into the interior through a spray nozzle 30 at the top of a spray pipe 29.

When the humidifier of the related art is used for a long period of time, the water tank 10 and the main body 20 are seriously contained by propagation of mold or bacteria, such that the humidifier for health rather becomes a cause of contaminating the interior air. In order to prevent this contamination, it is required to frequently clean the water tank 10 and the main body 20. In this configuration, the water tank 10 is separable and can be cleaned, but it is required to separate an individual cover 11 coupled to the water tank 10, such that it is complicated to clean and supply water while the water level sensor 27, the air blowing port, the water seat 21, a cable 32, and the ultrasonic oscillator 25 are integrally formed in the main body 20, such that the structure is very complicated and cleaning is not easy. Further, since the electronic circuit is provided in the main body 20, the water may flow into the air blowing port 26 and the main body 20 in cleaning and damage the insulation of the electronic circuit, such that the humidifier is likely to break and the user is likely to receive an electric shock.

Meanwhile, a humidifier implemented by providing the common humidifier described above with an aroma function is described hereafter.

FIG. 3 shows an aroma humidifier that has been publicized by Korean Utility Publication No. 91-1087. According to the configuration of the aroma humidifier, an air blowing fan 40 is disposed at a side of a case 42 with an aromatic sponge, such that air blown by the air blowing fan 40 flows through the case 42 and aroma is discharged outside through a nozzle 41.

However, the aroma humidifier is not largely different in the structure from the humidifier described above, such that cleaning is not easy. Further, an aromatic is disposed and used in the main body of the humidifier, such that a user cannot freely select and install an aromatic.

### DISCLOSURE

### Technical Problem

The present invention has been made in an effort to solve the problems and it is an object of the present invention to provide an aroma humidifier that can be freely installed and moved, has a simple structure to easily clean and supply water, and allows a user to freely add aromatic and cosmetic materials to achieve both humidification and aroma.

### Technical Solution

The present invention provides an ultrasonic aroma humidifier capable of facilitating cleaning which includes: a main body that is composed of a water container storing water, a water container seat where the water container is seated, a handle having a built-in air blowing port, and a water shortage indicating lamp; a vaporizer that is composed of an ultrasonic oscillator coupled to the bottom of the main body and generating sprayed mist by means of ultrasonic oscillation, a water level detecting sensor detecting the water level, a circuit board controlling the operation of the ultrasonic oscillator and turning on/off the water shortage indicating lamp to the outside of the main body when there is lack of water, and an electric connector supplying electric power to the ultrasonic oscillator; and a base that accommodates an electric connection protrusion 81 coupled to the electric connector, an ultrasonic oscillation circuit and a control circuit which respectively operates and controls the vaporizer, an air blowing fan taking in exterior air, a humidifying switch controlling the degree of humidification, a blowing switch controlling blowing intensity, and a power source cord cable, in which a cover is coupled to the top of the main body and has a humidifying outlet and a nozzle for discharging humidifying particles, and an attachable/detachable filter net and a stationary ring for storing an aroma and cosmetic material are attached to the inner side of the main body.

Further, it is preferable that the stationary ring is made of plastic or a stainless material and has an outer flange that is held on a step of the main body and an inner flange supporting the filter net.

Further, the filter net is made of a stainless material and the upper portion is made of a stainless material with a mesh such that a liquid-state or solid-state aroma material can disperse well.

Meanwhile, the filter net reduces a noise due to water drops by controlling water drops spattering up from the ultrasonic oscillator and the lower portion is depressed.

Further, the main body is made of transparent plastic with a scale.

Further, in the ultrasonic aroma humidifier capable of facilitating cleaning, it is possible to prevent the ultrasonic oscillator from being scratched or damaged in cleaning by attaching a corrosion-proof thin metal plate to one side of the ultrasonic oscillator.

### Advantageous Effects

As described above, according to the ultrasonic aroma humidifier capable of facilitating cleaning, the main body functions as both a water tank and a humidifying body and the air blowing port is formed in a handle shape with a simple interior structure. Further, the main body is independently separated from the base with the electronic circuit and the air blowing fan etc. by a contact point power transmission type, such that cleaning and supplying water are free and convenient. Furthermore, the humidifier can be freely moved and installed and the filter net for aroma is disposed in the main body, such that a user can easily add aroma and cosmetic materials to discharge the materials simultaneously with humidification.

### DESCRIPTION OF DRAWINGS

FIG. 1 is a plan view showing the top of a humidifying chamber of an ultrasonic humidifier of the related art.

FIG. 2 is a cross-sectional view showing a cross-section of the ultrasonic humidifier of the related art.

FIG. 3 is a cross-sectional view showing a cross-section of an aroma humidifier of the related art.

FIG. 4 is an exploded perspective view showing the structure of an ultrasonic aroma humidifier capable of facilitating cleaning according to an embodiment of the present invention.

FIG. 5 is a cross-sectional view showing the structure of the ultrasonic aroma humidifier capable of facilitating cleaning according to an embodiment of the present invention.

FIG. 6 is a cross-sectional view showing the structure of vaporizer according to an embodiment of the present invention.

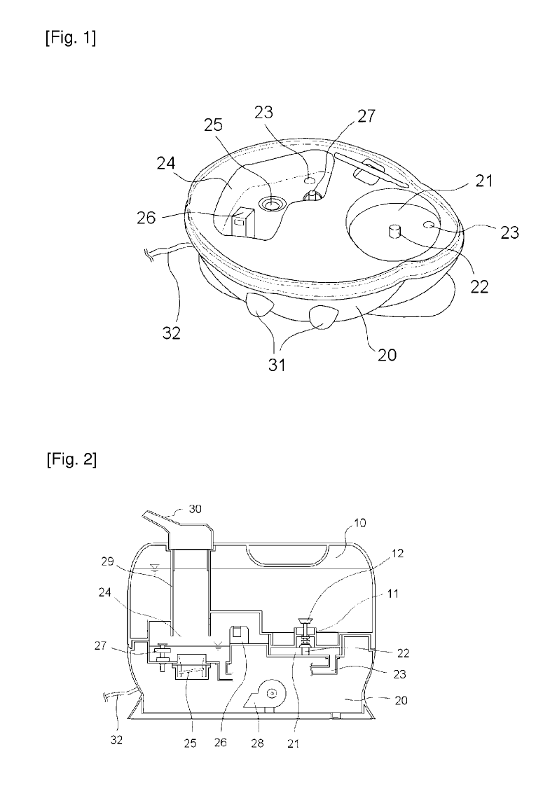

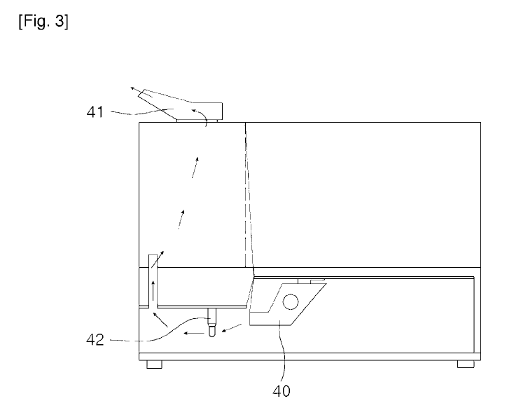

### BEST MODE

Hereinafter, preferred embodiments of the present invention are described in detail with reference to the accompanying drawings.

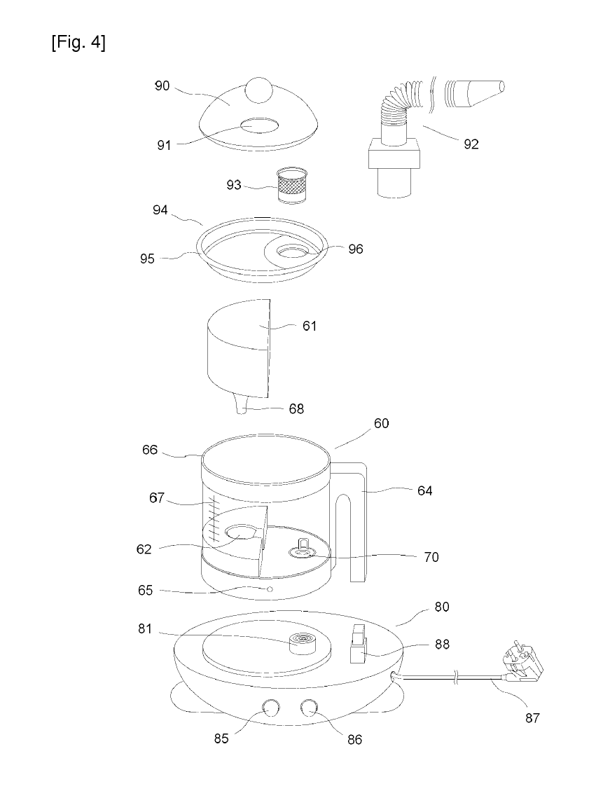

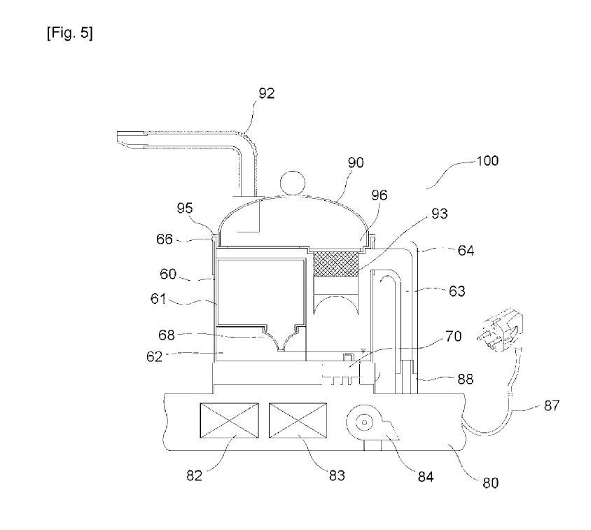

FIG. 4 is an exploded perspective view of an embodiment of the present invention and FIG. 5 is a cross-sectional view of FIG. 4.

An ultrasonic aroma humidifier 100 according to an embodiment of the present invention, as shown in FIGS. 4 and 5, includes: a main body 60 that is composed of a water container 61 storing water, a water container seat 62 where the water container 61 is seated, a handle 64 having a built-in air blowing port 63, and a water shortage indicating lamp 65; a vaporizer 70 that is composed of an ultrasonic oscillator 71 coupled to the bottom of the main body 60 and generating sprayed mist by means of ultrasonic oscillation, a water level detecting sensor 72 detecting the water level, a circuit board 73 controlling the operation of the ultrasonic oscillator and turning on/off the water shortage indicating lamp to the outside of the main body when there is lack of water, and an electric connector 74 supplying electric power to the ultrasonic oscillator 71; and a base 80 that accommodates an electric connection protrusion 81 coupled to the electric connector 74, an ultrasonic oscillation circuit 82 and a control circuit 83 which respectively operates and controls the vaporizer 70, an air blowing fan 84 taking in exterior air, a humidifying switch controlling the degree of humidification, a blowing switch 86 controlling blowing intensity, and a base 80 receiving a power source cord cable 87. In this configuration, a cover 90 is coupled to the top of the main body and has a humidifying outlet and a nozzle 92 for discharging humidifying particles, and an attachable/detachable filter net 93 and a stationary ring 94 for storing an aroma and cosmetic material are attached to the inner side of the main body.

In this configuration, it is preferable that the stationary ring 94 is made of plastic or a stainless material and has an outer flange 95 that is held on a step 66 of the main body and an inner flange 96 supporting the filter net 93.

It is preferable that a water supply cap 68 connected with the water container 61 is formed in a conical shape with the width decreasing to the end and seated in the water container seat 62, and reduce water supply noise and keep the water level by supplying water little by little when the main body is lack of water in order to increase spraying efficiency and be simply attached/detached when cleaning and supplying water.

It is preferable that the main body 60 has a cup shape to be easily carried when cleaning and supplying water and is made of transparent plastic with a scale 67 such that the amount of water in the water container can be seen from the outside when water is supplied or humidification is performed.

The handle 64 is made of plastic and allows the main body 60 to be easily carried for cleaning and supplying water, in addition to functioning as the air blowing port 63 through which the air from the air blowing fan 84 in the base 80 flows, such that the interior structure of the main body 60 is simplified. Further, the handle is easily detachably coupled to the base by being seated in a fitting groove 88 of the base 80. Further, various types of blowing air from the outside may be used to simplify the interior structure of the main body.

The humidifying outlet 91 may be provided with an individual nozzle 92 to control the spray direction and the filter net 93 is made of a stainless material in a cylindrical shape such that a user can put a liquid-state or solid-state aromatic to use it simultaneously with humidification, in which the upper portion of the filter net is made of a stainless material with a mesh such that the aromatic can disperse well. Further, it is preferable that the lower portion of the filter net 93 keeps a depressed shape such that large water particles in the sprayed water particles generated by the ultrasonic oscillator 71 can smoothly drop along the lower portion of the filter net 93 without making a noise due to water drops.

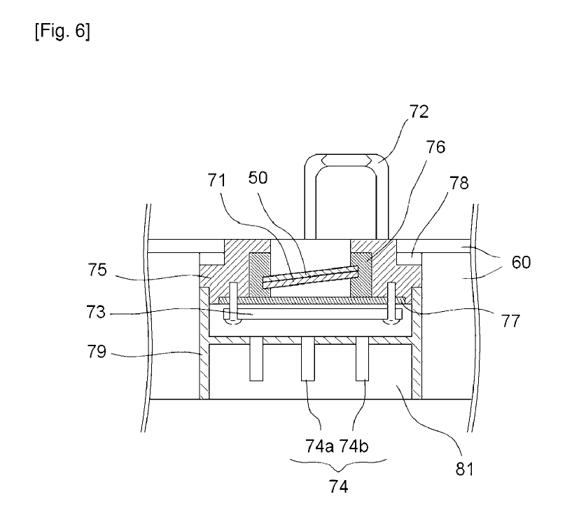

FIG. 6 is a view showing the structure of the vaporizer 70 coupled to the bottom of the main body 60. The water level detecting sensor 72 is disposed on the top of a heat dissipating plate 75 and the ultrasonic oscillator 71 is surrounded and fixed by support rubber 76 having inclined surfaces in the heat dissipating plate 75. The support rubber 76 is fixed by a support holder 77. An O-ring 78 for preventing water leakage is inserted between the heat dissipating plate 75 and the bottom of the main body 60. The circuit board 73 connected with the ultrasonic oscillator 71, the water level detecting sensor 72, and an electrode line (not shown) is disposed under the heat dissipating plate 75, such that when the water detecting sensor detects that the water decreases under a predetermined level, the circuit board recognizes the detection signal and stops the operation of the ultrasonic oscillator and shows a water shortage signal to the outside of the main body by turning on/off the water shortage indicating lamp 65. The electric connector 74 for supplying electric power to the ultrasonic oscillator 71 is composed of a circular contact point 74a and a ring-shaped contact point 74b and disposed inside a heat dissipating plate holder 79.

Meanwhile, a corrosion-proof thin metal plate 50 may be attached to one side of the ultrasonic oscillator 71 to prevent the ultrasonic oscillator 71 from being scratched or damaged in cleaning.

The operation of the ultrasonic aroma humidifier having the configuration described above, according to the present invention, is described hereafter. The humidifier is separated into the main body equipped with the vaporizer and the base and the water container in the main body is supplied with water and seated on the electric connection protrusion of the base. Thereafter, as a user operates the key of an input switch, the degree of humidification of the vaporizer and the blowing intensity of the air blowing fan are controlled by the ultrasonic oscillation circuit and the control circuit where the operational intensity of the humidifier is inputted, such that humidification and aroma are achieved while the water is discharged outside through the humidifying outlet and the nozzle at the top of the main body.

It will be apparent to those skilled in the art that the present invention described above is not limited to the embodiments described above and may be modified in various ways, without deviating from the spirit and scope of the present invention. Therefore, the modified and changed embodiments should be construed as being included in claims of the present invention.

1. An ultrasonic aroma humidifier 100 capable of facilitating cleaning, comprising:
a main body 60 that is composed of a water container 61 storing water, a water container seat 62 where the water container 61 is seated, a handle 64 having a built-in air blowing port 63, and a water shortage indicating lamp 65;
a vaporizer 70 that is composed of an ultrasonic oscillator 71 coupled to the bottom of the main body 60 and generating sprayed mist by means of ultrasonic oscillation, a water level detecting sensor 72 detecting the water level, a circuit board 73 controlling the operation of the ultrasonic oscillator and turning on/off the water shortage indicating lamp to the outside of the main body when there is lack of water, and an electric connector 74 supplying electric power to the ultrasonic oscillator 71; and
a base 80 that accommodates an electric connection protrusion 81 coupled to the electric connector 74, an ultrasonic oscillation circuit 82 and a control circuit 83 which respectively operates and controls the vaporizer 70, an air blowing fan 84 taking in exterior air, a humidifying switch 85 controlling the degree of humidification, a blowing switch 86 controlling blowing intensity, and a power source cord cable 87,
wherein a cover 90 is coupled to the top of the main body and has a humidifying outlet 91 and a nozzle 92 for discharging humidifying particles, and an attachable/detachable filter net 93 and a stationary ring 94 for storing an aroma and cosmetic material are attached to the inner side of the main body.

2. The ultrasonic aroma humidifier capable of facilitating cleaning according to claim 1, wherein the stationary ring 94 is made of plastic or a stainless material and has an outer flange 95 that is held on a step 66 of the main body and an inner flange 96 supporting the filter net 93.

3. The ultrasonic aroma humidifier capable of facilitating cleaning according to claim 1, wherein a water supply cap 68 connected with the water container 61 is formed in a conical shape with the width decreasing to the end, reduces water supply noise and improving spray efficiency by being seated in the water container seat 62, and is simply attached/detached for the convenience of cleaning and supplying water.

4. The ultrasonic aroma humidifier capable of facilitating cleaning according to claim 1, wherein the main body 60 has a cup shape to be easily carried when cleaning and supplying water and is made of transparent plastic with a scale 67 such that the amount of water in the water container can be seen from the outside when water is supplied or humidification is performed.

5. The ultrasonic aroma humidifier capable of facilitating cleaning according to claim 1, wherein the nozzle 92 for discharging water for humidification is formed a wrinkled hose to control the spray direction.

6. The ultrasonic aroma humidifier capable of facilitating cleaning according to claim 1, wherein the handle 64 is made of plastic and allows the main body 60 to be easily carried for cleaning and supplying water, in addition to functioning as the air blowing port 63 through which the air from the air blowing fan 84 flows, such that the interior structure of the main body 60 is simplified, and is easily detachably coupled to the base by being seated in a fitting groove 88 of the base 80.

7. The ultrasonic aroma humidifier capable of facilitating cleaning according to claim 1, wherein the filter net 93 is made of a stainless material in a cylindrical shape such that a user can put a liquid-state or solid-state aromatic to use it simultaneously with humidification, the upper portion of the filter net is made of a stainless material with a mesh such that the aromatic can disperse well, and the lower portion of the filter net 93 keeps a depressed shape such that large water particles in the sprayed water particles generated by the ultrasonic oscillator 71 can smoothly drop along the lower portion of the filter net 93 without making a noise due to water drops.

8. The ultrasonic aroma humidifier capable of facilitating cleaning according to claim 1, wherein a corrosion-proof thin metal plate 50 is attached to one side of the ultrasonic oscillator 71 to prevent the ultrasonic oscillator 71 from being scratched or damaged in cleaning.

9. The ultrasonic aroma humidifier capable of facilitating cleaning according to claim 1, wherein the humidifier uses an external power source through a cable 87 and is charged by a battery.
